(19) United States
(12) Patent Application Publication
(10) Pub. No.: US 2011/0025472 A1
(43) Pub. Date: Feb. 3, 2011

(54) CONNECTION PORT SYSTEM

(75) Inventor: Hee Bok Kang, Cheongju (KR)

Correspondence Address: AMPACC Law Group, PLLC, 6100 219th Street SW, Suite 580, Mountlake Terrace, WA, 98043, US

(73) Assignee: Hynix Semiconductor Inc., Icheon (KR)

(21) Appl. No.: 12/774,651

(22) Filed: May 5, 2010

(30) Foreign Application Priority Data
Jul. 31, 2009 (KR) 10-2009-0070480
Nov. 25, 2009 (KR) 10-2009-0114411

(51) Int. Cl. H04Q 5/22

(52) U.S. Cl. 340/10.4

(57) ABSTRACT

A system comprises a RFID chip, a connection port coupled to an external apparatus, and an interface unit configured to electrically couple the connection port to the RFID chip.

### CROSS-REFERENCES TO RELATED APPLICATIONS

This application is based upon and claims the benefit of priority to Korean Patent Applications Nos. 10-2009-0070480 and 10-2009-0114411, respectively filed on Jul. 31, 2009 and Nov. 25, 2009, the entire contents of which are incorporated herein by reference.

### BACKGROUND OF THE INVENTION

A Radio Frequency Identification (RFID) is a kind of communication method to provide a contactless auto identification by using a wireless signal which is a RFID chip attached to a target of identification in order to automatically identify the target and a RFID reader configured to transmit a wireless signal with the RFID chip. The RFID may improve a conventional optical character recognition technology as well as advance a conventional automatic identification system such as a bar code system.

Recently, uses for a RFID system include a distribution system (logistics), an access authentication system, an electronic payment system, an access card system in transportations and securities, and so on.

For example, an integrated circuit (IC) chip including identification information instead of a delivery sheet or tag, slip or chip is used for inventory control and classification in the logistics. In the access authentication system, entry to an office or a system is determined by an IC card including personal information.

An RFID device stores data in a memory, the RFID chip may comprise a nonvolatile ferroelectric memory configured to store some information.

Generally, a non-volatile ferroelectric memory (e.g., a ferroelectric Random Access Memory (FeRAM)) has a data processing speed similar to that of a Dynamic Random Access Memory (DRAM). Also a FeRAM preserves data even in a case where power is turned off, such that many developers are conducting intensive research into FeRAM as a next generation memory device.

The above-mentioned FeRAM has a very similar structure to that of DRAM, and uses a ferroelectric capacitor as a memory device. The ferroelectric substance has high residual polarization characteristics, such that data is not lost although an electric field is removed.

FIG. 1 is a block diagram describing a conventional RFID system.

As shown, the conventional RFID system includes an antenna unit ANT, an analog processing unit 10, a digital processing unit 20, and an information storing unit 30.

In this case, the antenna unit ANT receives a radio frequency (RF) signal from an external RFID reader. The RF signal from the antenna unit ANT is input to the analog processing unit 10 via antenna pads 11 and 12.

The analog processing unit 10 amplifies the input RF signal, such that it generates a power-supply voltage VDD providing a driving voltage of an RFID tag. The analog processing unit 10 detects an operation command signal from the input RF signal, and outputs a command signal CMD to the digital processing unit 20. In addition, after the analog processing unit 10 detects the output voltage VDD, it outputs a power-on reset signal POR for controlling a reset operation and also a clock CLK to the digital processing unit 20.

The digital processing unit 20 receives the power voltage VDD, the power-on reset signal POR, the clock CLK, and the command signal CMD from the analog processing unit 10, and outputs a response signal RP in response to the received signals to the analog processing unit 10. The digital processing unit 20 outputs an address ADD, Input/Output data (I/O), a control signal CTR, and a clock CLK to the information storing unit 30.

The information storing unit 30 reads or writes the input/output data I/O using a memory device at a location corresponding to the address ADD and preserves the data even after the power is turned off.

In this case, the RFID device uses frequencies of various bands. In general, as the value of a frequency band is lowered, the RFID device has a lower recognition speed, has a shorter operation distance, and is less affected by surrounding environment. In contrast, as the value of a frequency band is increased, the RFID device has a higher recognition speed, has a greater operation distance, and is considerably affected by surrounding environment.

Meanwhile, a conventional connection port transmits a wireless signal via an antenna between a RFID reader and a RFID chip; but if there is interference or jamming between the RFID reader and the RFID chip, a recognition rate decreases.

### SUMMARY OF THE INVENTION

An embodiment of the present invention is to provide a communication system comprising an interface unit coupled to a RFID chip and configured to communicate a wireless signal with a RFID reader via an antenna as well as transmit a signal with an external device via a connection port.

An embodiment of the present invention is to provide a communication system configured to selectively control an enablement of connection ports coupled to an external apparatus such as a computer so that an additional security program might be unnecessary.

An embodiment of the present invention is to provide a communication system comprising a security processing unit included in a RFID chip and configured to perform a security setting by a wireless signal.

According to an embodiment of the present invention, a connection port system comprises a RFID chip, a connection port coupled to an external apparatus, and an interface unit configured to electrically couple the connection port to the RFID chip.

According to an embodiment of the present invention, a connection port system comprises a connection port coupled to an external apparatus; an interface unit coupled to input and output terminals of the connection port; and a RFID chip coupled to the interface unit, wherein the interface unit configured to control a connection stage of the input and output terminals in response to a security control signal outputted from the RFID chip.

### BRIEF DESCRIPTION OF THE DRAWINGS

FIG. 1 is a block diagram describing a conventional RFID system.

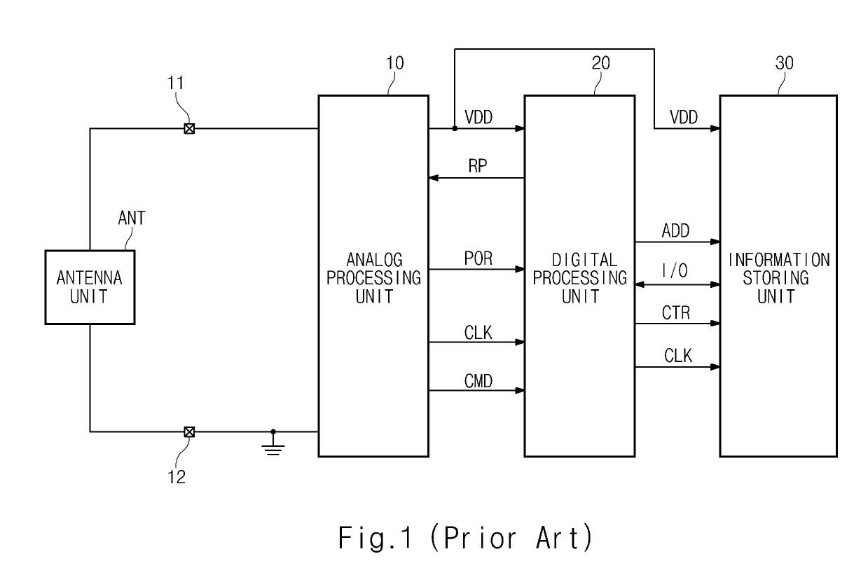

FIG. 2 is an view illustrating a mobile terminal comprising a connection port system according to an embodiment of the present invention.

FIG. 3 is a block diagram showing a RFID chip according to an embodiment of the present invention.

FIG. 4 is a block diagram showing a connection port system according to an embodiment of the present invention.

FIG. 5 is a timing diagram describing operation of the connection port system shown in FIG. 4.

FIG. 6 is a block diagram showing a connection port system according to another embodiment of the present invention.

FIG. 7 is a timing diagram describing operation of the connection port system shown in FIG. 6.

FIG. 8 is a block diagram showing a connection port system according to another embodiment of the present invention.

FIG. 9 is a timing diagram describing operation of the connection port system shown in FIG. 8.

FIG. 10 is a block diagram showing a connection port system according to another embodiment of the present invention.

FIG. 11 is a block diagram describing operation of the connection port system shown in FIG. 10.

FIG. 12 is a block diagram showing a connection port system according to another embodiment of the present invention.

FIG. 13 is a block diagram showing a RFID chip shown in FIG. 12.

### DESCRIPTION OF EMBODIMENTS

Hereinafter, specific embodiment of the present invention will be described with reference to the accompanying drawings. The drawings are not necessarily to scale and in some instances, proportions may have been exaggerated in order to more clearly depict certain features of the invention.

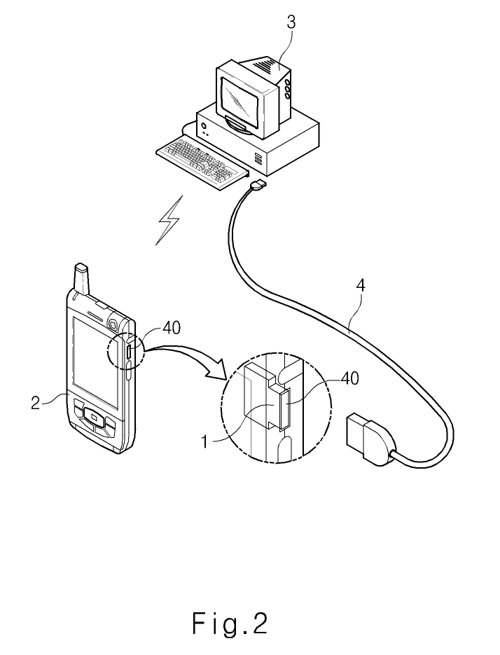

FIG. 2 is an view illustrating a mobile terminal 2 comprising a connection port system 1 according to an embodiment of the present invention.

As shown, the connection port system 1 may be included in the mobile terminal 2. The connection port system 1 includes a connection port 40 configured to couple the mobile terminal 2 to an external apparatus such as a personal computer 3 by a wire, and a circuit (not shown) configured to communicate between the mobile terminal 2 and the personal computer 3 wirelessly. That is, the connection port system 1 can allow the mobile terminal 2 to communicate with the external apparatus by both wire and wireless systems.

An internal circuit in the mobile terminal 2 is coupled to the connection port system 1, and the connection port system 1 is coupled to the personal computer 3 as the external device through the connection port 40 and a connection cable 4 connected to the connection port 40. As a result, the internal circuit in the mobile terminal 2 can transmit data to the personal computer 3 by a wire.

Meanwhile, the internal circuit is coupled to the connection port system 1, and the connection port system 1 includes the circuit supporting a wireless communication. Because of including a RFID chip, the connection port system 1 can communicate with the external apparatus such as the personal computer 3 including a RFID reader.

As described above, if the connection port system 1 according to an embodiment of the present invention applies to an apparatus, the apparatus may communicate with an external device via the connection port 40 in a wire, or transmits a wireless signal to the external device without a wire.

In the above embodiment, the connection port system 1 is applied to the mobile terminal 2. However, according to another embodiment of the present invention, the connection port system 1 may be applied to various electronic devices such as a PDA, a PMP, a MP3 player, a digital camera, and etc.

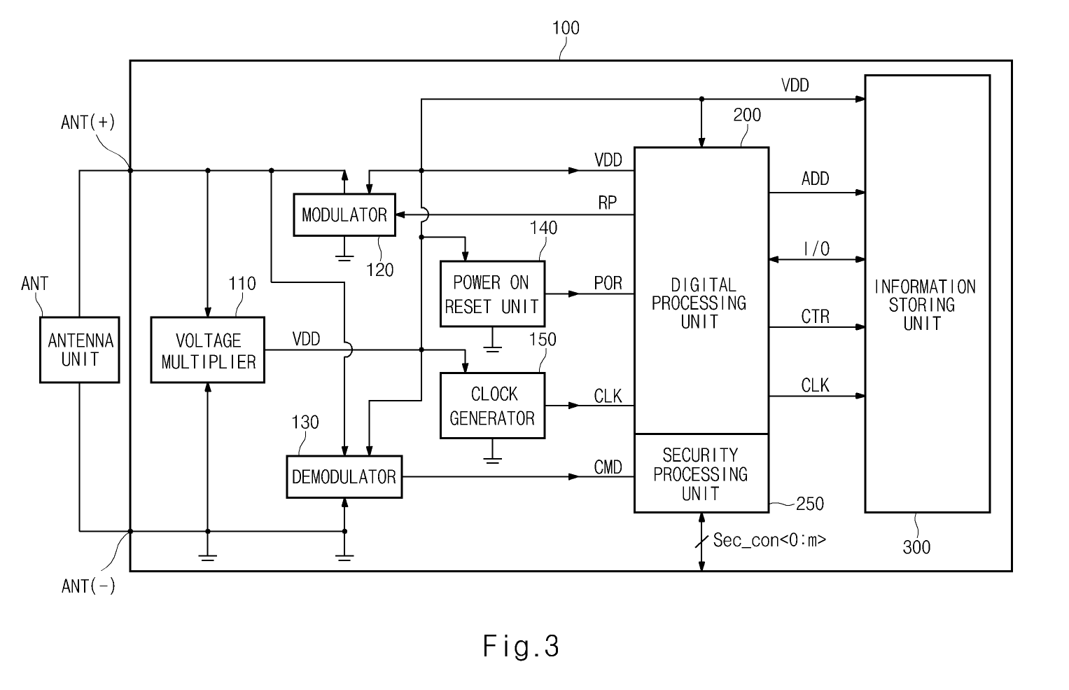

FIG. 3 is a block diagram showing a RFID chip 100 according to an embodiment of the present invention.

As shown, the RFID chip 100 includes a voltage multiplier 110, a modulator 120, a demodulator 130, a power-on-reset unit 140, a clock generator 150, a digital processing unit 200, and an information storing unit 300. The digital processing unit 200 includes a security processing unit 250.

An antenna unit ANT receives a radio frequency (RF) signal transmitted from a RFID reader. The radio frequency signal is inputted to the RFID chip 100 through antenna pads ANT(+) and ANT(−).

The voltage multiplier 110 rectifies the radio frequency signal delivered from the antenna unit ANT and boosts up a voltage level to generate a power voltage VDD.

The modulator 120 modulates a response signal RP inputted from the digital processing unit 200 to transmit a modulated signal to the antenna ANT. The demodulator 130 demodulates a signal inputted through the antenna ANT according to the power voltage VDD and outputs the command signal CMD to the digital processing unit 200.

The power-on-reset unit 140 senses the power voltage VDD generated by the voltage multiplier 110 and outputs a power-on-reset signal POR to the digital processing unit 200. Herein, the power-on-reset signal POR for controlling a reset operation of internal circuits in the RFID chip 100 rises along with the power voltage VDD while the power voltage VDD transitions from a low level to a high level, and changes from the high level to the low level at a period when the power voltage VDD boosts up to the high level.

The clock generator 150 outputs a clock CLK to the digital processing unit 200. The clock CLK is for controlling an operation of the digital processing unit 200 according to the power voltage VDD generated from the voltage multiplier 110.

Receiving the power voltage VDD, the power-on-reset signal POR, the clock CLK and a command signal CMD, the digital processing unit 200 decodes the command signal CMD to generate a control signal CTR and a plurality of process signals. Also, the digital processing unit 200 outputs the response signal RP corresponding to the control signal CTR and the plurality of process signals to the modulator 120. The digital processing unit 200 outputs an address ADD, an input/output data I/O, the control signal CTR, and the clock CLK to the information storing unit 300.

Herein, the address ADD is a signal for informing which memory cells the input/output data I/O is stored. The control signal CTR includes one or more signals used for controlling an operation to read the input/output data I/O from the information storing unit 300 or write the input/output data I/O to the information storing unit 300.

The plurality of process signals including a chip enable signal, a write signal, and output enable signal. The chip enable signal enables an operation of the information storing unit 300. The write enable signal enables a write operation for storing the input/output data I/O in the information storing unit 300. The output enable signal allows a read operation for outputting the input/output data I/O from the information storing unit 300.

The security processing unit 250 outputs a security control signal Sec_con<0:m> to control a security function in response to the command signal CMD inputted from the demodulator 130. If a signal for setting a security function is inputted from an external RFID reader through the antenna unit ANT, the voltage multiplier 110 and the demodulator 130 outputs the command signal CMD for setting a security function to the security processing unit 250. Accordingly, the RFID chip may easily set a security function in the security processing unit 250 in response to a wireless signal delivered from an external device.

The information storing unit 300 includes a plurality of memory cells, each being able to store inputted data and output stored data.

The information storing unit 300 also includes a nonvolatile memory block. The nonvolatile memory block can include FeRAM. The data processing speed of FeRAM is typically similar to that of Dynamic Random Access Memory (DRAM). The structure of FeRAM is also similar to that of DRAM in that FeRAM includes a plurality of capacitors. However, the capacitors in a FeRAM device are made of a ferroelectric material having a high residual polarization, which in turn allows for data retention even when the power supplied to the memory device is terminated.

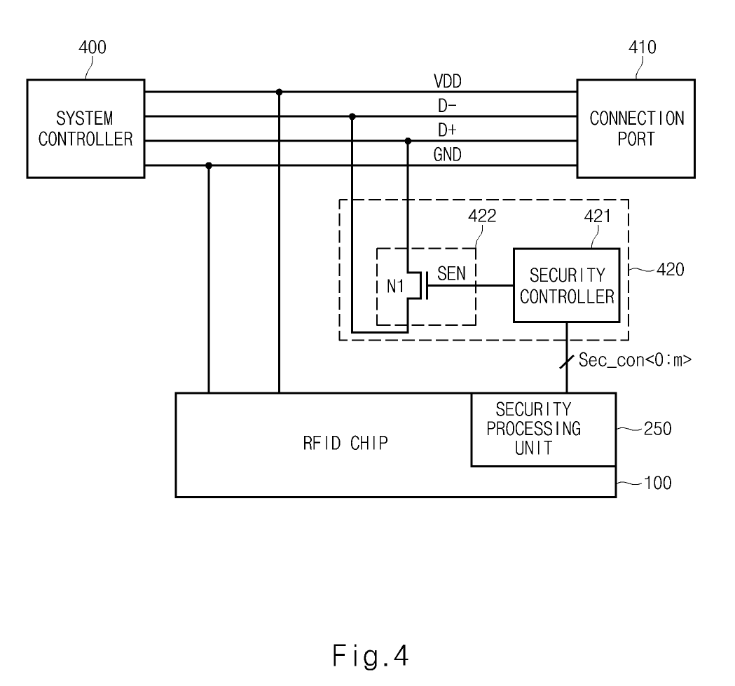

FIG. 4 is a block diagram showing a connection port system according to an embodiment of the present invention.

As shown, the connection port system includes a RFID chip 100, an interface unit 420, a system controller 400, and a connection port 410. The connection port system may be fabricated in one chip. The RFID chip 100 includes a security processing unit 250.

The connection port 410 includes a universal serial bus (USB) port. Furthermore, in another embodiment, the connection port 410 can include one or more ports such as a USB port, a 1394 port, a serial port, etc.

The system controller 400 is coupled to the connection port 410 via a plurality of wires for transferring a power voltage VDD, a ground voltage GND, input and output terminals D− and D+. The power voltage VDD and the ground voltage GND are commonly coupled to the system controller 400 and the connection port 410 as well as the RFID chip 100.

The security processing unit 250 outputs a security control signal Sec_con<0:m> to the interface unit 420. Through the input and output terminals D− and D+, the interface unit 420 is coupled to the connection port 410.

According to the security control signal Sec_con<0:m> outputted from the security processing unit 250, the interface unit 420 selectively couples the system controller 400 to the connection port 410 via the input and output terminals D− and D+.

The system controller 400 controls an operation of the RFID chip 100. The system controller 400 is coupled to the RFID chip 100 via the power voltage VDD and the ground voltage GND. As a result, the system controller 400 may selectively supply or block a power source including the power voltage VDD and the ground voltage GND to control an operation of the RFID chip 100.

The connection port 410 may be coupled to an interface included in an external apparatus such as a personal computer. If the input and output terminals D− and D+ of the connection port 410 is coupled to the interface of the external apparatus, an external input signal can be inputted from the external apparatus to the connection port 410 via the input and output terminals D− and D+. The security control signal Sec_con<0:m> outputted from the RFID chip 100 is delivered to the interface unit 420. Output signals of the interface unit 420 may selectively block connections of the input and output terminals D− and D+ of the connection port 410.

The interface unit 420 includes a security controller 421 and a driving unit 422.

The security controller 412 selectively activates a security enable signal SEN in response to the security control signal Sec_con<0:m> outputted from the RFID chip 100.

The driving unit 422 includes a NMOS transistor N1 serving as a switching device. The NMOS transistor N1 coupled between the input and output terminals D− and D+ has a gate coupled to the security enable signal SEN. When the security enable signal SEN is activated as a logic high level, the NMOS transistor N1 is turned on to couple the input and output terminals D− and D+.

The driving unit 422 has a high resistance in the case when the input and output terminals D− and D+ are not coupled to each other. Otherwise, when the input and output terminals D− and D+ are coupled to each other (i.e., electrically connected) the driving unit 422 has a low resistance. If the input and output terminals D− and D+ are coupled to each other, information may not be read, written, or transmitted to the external apparatus such as a computing system via the connection port 410.

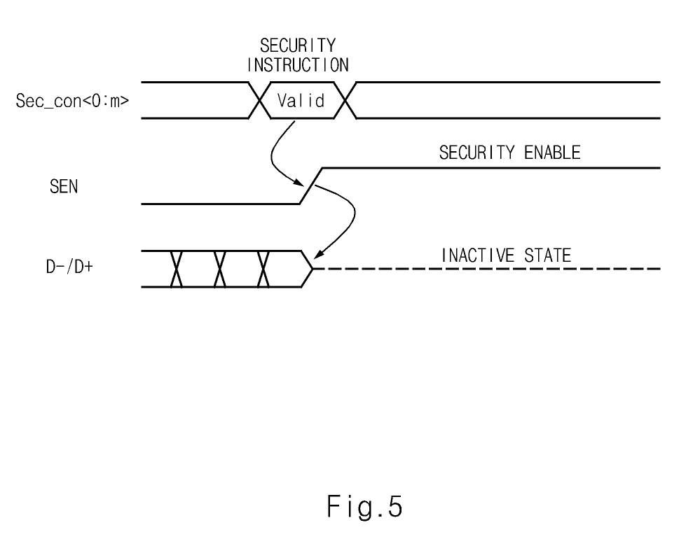

FIG. 5 is a timing diagram describing operation of the connection port system shown in FIG. 4.

Through the antenna unit ANT, a security command is wirelessly inputted to the RFID chip 100. The security command is demodulated by the demodulator 130 and inputted to the security processing unit 250.

The security processing unit 250 decodes the security command outputted from the demodulator 130. If the decoding result is true (i.e., the security command is a predetermined security instruction) the security processing unit 250 activates the security control signal Sec_con<0:m>.

If the security control signal Sec_con<0:m> is activated and inputted into the security controller 421, the security controller 421 outputs the security enable signal SEN having a logic high level. When the security enable signal SEN is in a logic high level, a security function of system is set.

When the security enable signal SEN becomes a logic high level, the NMOS transistor N1 is turned on. As a result, the input and output terminals D− and D+ electrically short and a resistance of the NMOS transistor N1 becomes low. There is no potential difference between the input and output terminals D− and D+ (i.e., potentials of the input and output terminals D− and D+ are equalized) so that data communication cannot be performed via the input and output terminals D− and D+. That is, if the security function of system is set, data transmission via the connection port 410 is blocked.

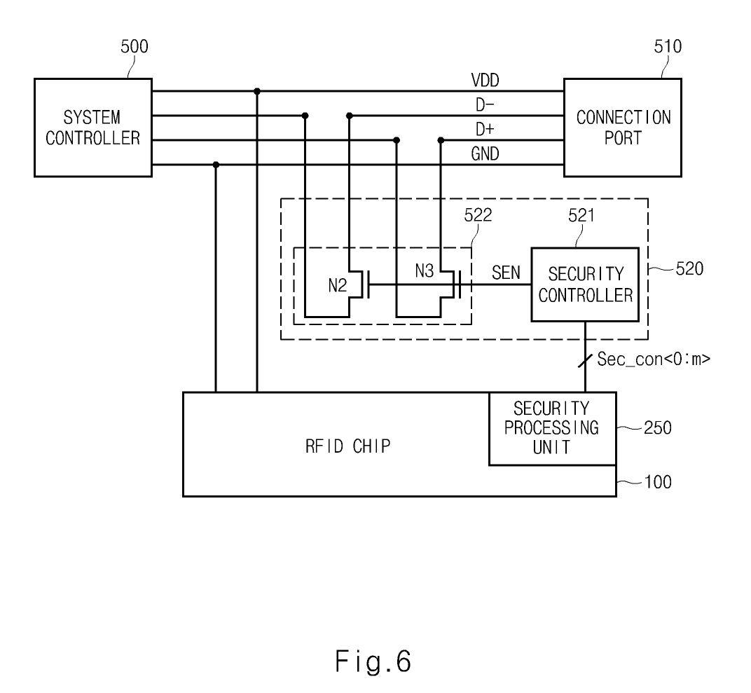

FIG. 6 is a block diagram showing a connection port system according to another embodiment of the present invention.

As shown, the connection port system includes a RFID chip 100, an interface unit 520, a system controller 500, and a connection port 510. The connection port system may be fabricated in one chip. The RFID chip 100 includes a security processing unit 250.

The connection port 510 includes a universal serial bus (USB) port. Furthermore, in another embodiment, the connection port 510 can include one or more ports such as a USB port, a 1394 port, a serial port, and etc.

The system controller 500 is coupled to the connection port 510 via a plurality of wires for transferring a power voltage VDD, a ground voltage GND, input and output terminals D− and D+. The power voltage VDD and the ground voltage GND are commonly coupled to the system controller 500 and the connection port 510 as well as the RFID chip 100.

The security processing unit 250 outputs a security control signal Sec_con<0:m> to the interface unit 520. Through the input and output terminals D− and D+, the interface unit 520 is coupled to the connection port 510.

According to the security control signal Sec_con<0:m> outputted from the security processing unit 550, the interface unit 520 selectively couples the system controller 500 to the connection port 510 via the input and output terminals D− and D+.

The system controller 500 controls an operation of the RFID chip 100. The system controller 500 is coupled to the RFID chip 100 via the power voltage VDD and the ground voltage GND. As a result, the system controller 500 may selectively supply or block a power source including the power voltage VDD and the ground voltage GND to control an operation of the RFID chip 100.

The connection port 510 may be coupled to an interface included in an external apparatus such as a personal computer. If the input and output terminals D− and D+ of the connection port 510 is coupled to the interface of the external apparatus, an external input signal can be inputted from the external apparatus to the connection port 510 via the input and output terminals D− and D+. The security control signal Sec_con<0:m> outputted from the RFID chip 100 is delivered to the interface unit 520. Output signals of the interface unit 520 may selectively block connections of the input and output terminals D− and D+ of the connection port 510.

The interface unit 520 includes a security controller 521 and a driving unit 522.

The security controller 512 selectively activates a security enable signal SEN in response to the security control signal Sec_con<0:m> outputted from the RFID chip 100.

The driving unit 522 includes first and second NMOS transistors N2 and N3 serving as switching devices. The first NMOS transistor N2 with the source and drain coupled to the input and output terminal D− between the system controller 500 and the connection port 510. The first NMOS transistor also has a gate coupled to the security enable signal SEN. The second NMOS transistor N3 with the source and drain coupled to the input and output terminals D+ between the system controller 500 and the connection port 510. The first NMOS transistor also has a gate coupled to the security enable signal SEN.

When the security enable signal SEN is activated as a logic low level, the first and second NMOS transistors N2 and N3 are turned off. Accordingly, the input and output terminals D− coupled to the system controller 500 and the connection port 510 are electrically disconnected from each other, and the input and output terminals D+ coupled to the system controller 500 and the connection port 510 are also electrically disconnected from to each other. If all of the input and output terminals D− and D+ are respectively disconnected, information may be not read, write, or transmitted to the external apparatus via the connection port 410.

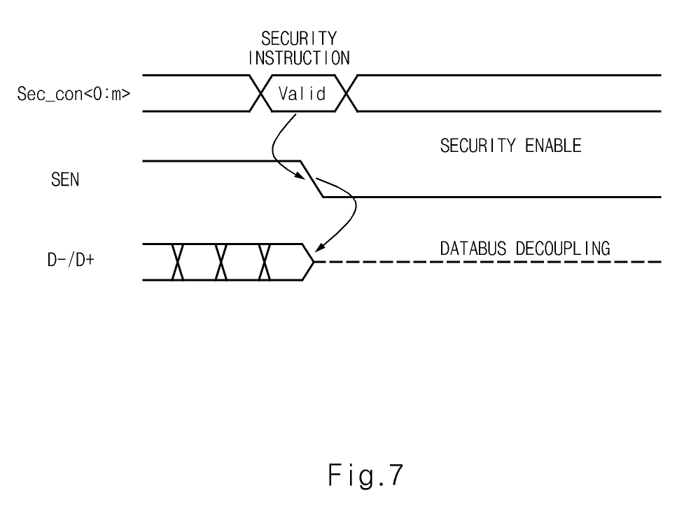

FIG. 7 is a timing diagram describing operation of the connection port system shown in FIG. 6.

Through the antenna unit ANT, a security command is wirelessly inputted to the RFID chip 100. The security command is demodulated by the demodulator 130 and inputted to the security processing unit 250.

The security processing unit 250 decodes the security command outputted from the demodulator 130. If the decoding result is true (i.e., the security command is a predetermined security instruction) the security processing unit 250 activates the security control signal Sec_con<0:m>.

If the security control signal Sec_con<0:m> is activated and inputted into the security controller 521, the security controller 521 outputs the security enable signal SEN having a logic high level. When the security enable signal SEN is in a logic high level, a security function of the system is set.

When the security enable signal SEN becomes a logic low level, the first and second NMOS transistors N2 and N3 are turned off. As a result, all of the input and output terminals D− and D+ are respectively decoupled. That is, the input and output terminals D− coupled to the system controller 500 and the connection port 510 are electrically disconnected from each other, and the input and output terminals D+ the system controller 500 and the connection port 510 are also electrically disconnected from each other. Accordingly, data communication cannot be performed via the input and output terminals D− and D+. That is, if the security function of the system is set (i.e., SEN signal is high), data transmission via the connection port 510 is allowed.

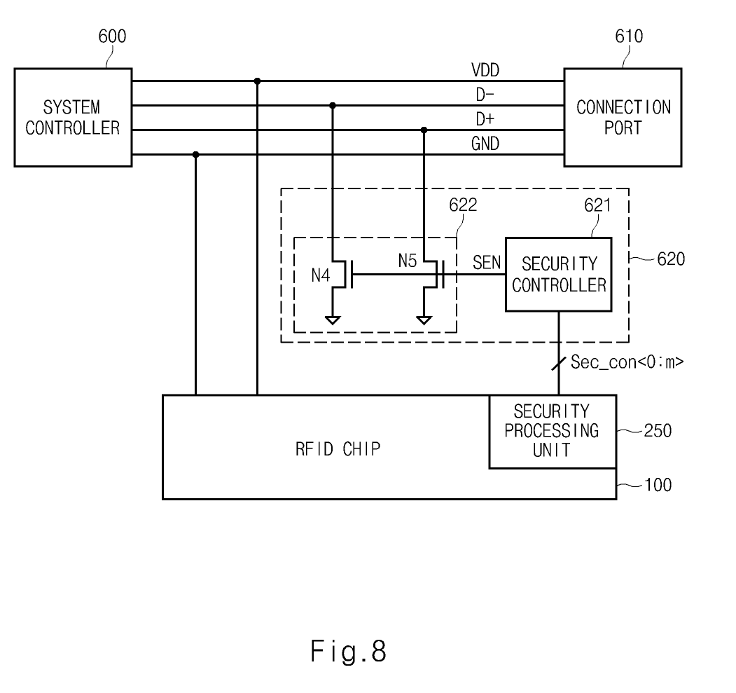

FIG. 8 is a block diagram showing a connection port system according to another embodiment of the present invention.

As shown, the connection port system includes a RFID chip 100, an interface unit 620, a system controller 600, and a connection port 610. The connection port system may be fabricated in one chip. The RFID chip 100 includes a security processing unit 250.

The connection port 610 includes a universal serial bus (USB) port. Furthermore, in another embodiment, the connection port 610 can include one or more ports such as a USB port, a 1394 port, a serial port, and etc.

The system controller 600 is coupled to the connection port 610 via a plurality of wires for transferring a power voltage VDD, a ground voltage GND, input and output terminals D− and D+. The power voltage VDD and the ground voltage GND are commonly coupled to the system controller 600 and the connection port 610 as well as the RFID chip 100.

The security processing unit 250 outputs a security control signal Sec_con<0:m> to the interface unit 620. Through the input and output terminals D− and D+, the interface unit 620 is coupled to the connection port 610.

According to the security control signal Sec_con<0:m> outputted from the security processing unit 650, the interface unit 620 controls the potentials of the input and output terminals D− and D+.

The system controller 600 controls an operation of the RFID chip 100. The system controller 600 is coupled to the RFID chip 100 via the power voltage VDD and the ground voltage GND. As a result, the system controller 600 may selectively supply or block a power source including the power voltage VDD and the ground voltage GND to control an operation of the RFID chip 100.

The connection port 610 may be coupled to an interface included in an external apparatus such as a personal computer. If the input and output terminals D− and D+ of the connection port 610 is coupled to the interface of the external apparatus, an external input signal can be inputted from the external apparatus to the connection port 610 via the input and output terminals D− and D+. The security control signal Sec_con<0:m> outputted from the RFID chip 100 is delivered to the interface unit 620. Output signals of the interface unit 620 may selectively pull down the input and output terminals D− and D+ of the connection port 610.

The interface unit 620 includes a security controller 621 and a driving unit 622.

The security controller 621 selectively activates a security enable signal SEN in response to the security control signal Sec_con<0:m> outputted from the RFID chip 100.

The driving unit 622 includes first and second NMOS transistors N4 and N5 serving as switching devices. The first NMOS transistor N4 coupled between the input and output terminal D− and the ground voltage GND has a gate coupled to the security enable signal SEN. The second NMOS transistor N5 coupled between the input and output terminal D+ and the ground voltage GND has a gate coupled to the security enable signal SEN.

When the security enable signal SEN is activated as a logic high level, the first and second NMOS transistors N4 and N5 is turned on so that the input and output terminals D− and D+ are coupled to the ground voltage GND. If all of the input and output terminals D− and D+ are electrically connected to the ground voltage GND, information may be not read, write, or transmitted to the external apparatus via the connection port 610.

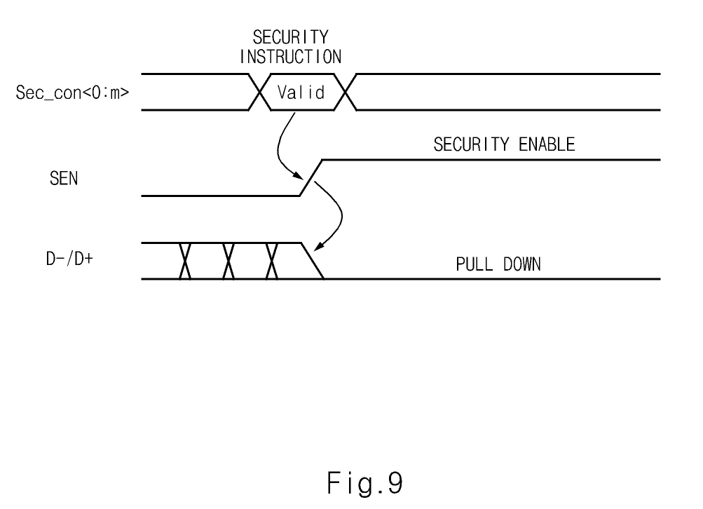

FIG. 9 is a timing diagram describing operation of the connection port system shown in FIG. 8.

Through the antenna unit ANT, a security command is wirelessly inputted to the RFID chip 100. The security command is demodulated by the demodulator 130 and inputted to the security processing unit 250.

The security processing unit 250 decodes the security command outputted from the demodulator 130. If the decoding result is true (i.e., the security command is a predetermined security instruction) the security processing unit 250 activates the security control signal Sec_con<0:m>.

If the security control signal Sec_con<0:m> is activated and inputted into the security controller 621, the security controller 621 outputs the security enable signal SEN having a logic high level. When the security enable signal SEN is in a logic high level, a security function of the system is set.

When the security enable signal SEN becomes a logic high level, the first and second NMOS transistors N2 and N3 are turned on. As a result, all of the input and output terminals D− and D+ are coupled to the ground voltage GND. That is, potentials of the input and output terminals D− and D− are pull down to the ground voltage GND so that data communication cannot be performed via the input and output terminals D− and D+. That is, if the security of system is set, data transmission via the connection port 610 is blocked.

A mobile apparatus such as a cellular phone, a notebook, and so on as well as a non-mobile apparatus such as a desktop includes a port or a connection unit for data transmission and communication with an external apparatus.

In an embodiment of the present invention, for setting a security function in the data transmission and communication, the RFID chip can control a validity of the port or the connection unit. For example, the RFID chip may enable or disable an operation of the port or the connection unit. The RFID chip for setting a security function in data communication can simplify internal structures of wired/wireless communication systems and allow users to easily handle or operate the wired/wireless communication system. Accordingly, additional security software for setting a security function is not required, and additional sticker-seal at any component for disabling the data communication is also unnecessary.

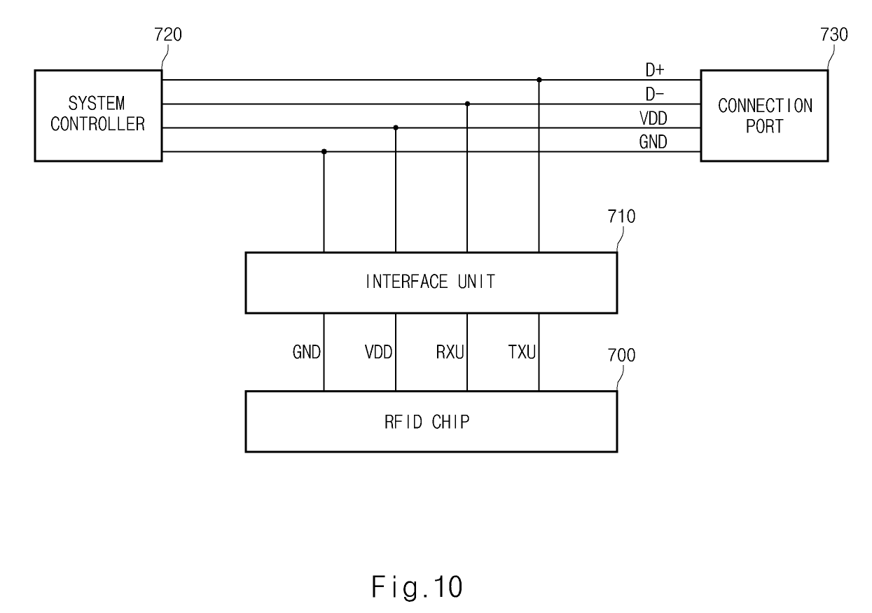

FIG. 10 is a block diagram showing a connection port system according to another embodiment of the present invention.

As shown, the connection port system includes a RFID chip 700, an interface unit 710, a system controller 720, and a connection port 730. The connection port system may be fabricated in one chip.

The RFID chip 700 receives an input signal RXU, a power voltage VDD, and a ground voltage GND from the interface unit 710, and outputs an output signal TXU to the interface unit 710.

In response to an external input signal via input and output terminals D+ and D− from the connection port 730, the interface unit 710 generate the input signal RXU to the RFID chip 700. Further, interface unit 710 generates the input signal based on the output signal TXU provided from the RFID chip 700 and transmits the inputted signal to the input and output terminals D+ and D−.

The system controller 720 controls operation of the RFID chip 700. For example, the system controller 720 controls the input signal RXU via the interface unit 710. The interface unit 710 inputs the input signal RXU to the RFID chip 700 in order to perform a test for checking whether internal circuits of the RFID chip 700 are operating normally.

The connection port 730 may be coupled to an interface included in an external apparatus such as a personal computer. If the input and output terminals D− and D+ of the connection port 730 is coupled to the interface of the external apparatus, an external input signal can be inputted from the external apparatus to the connection port 730 via the input and output terminals D− and D+. The external input signal is converted into the input signal RXU by the interface unit 710 and inputted into the RFID chip 700.

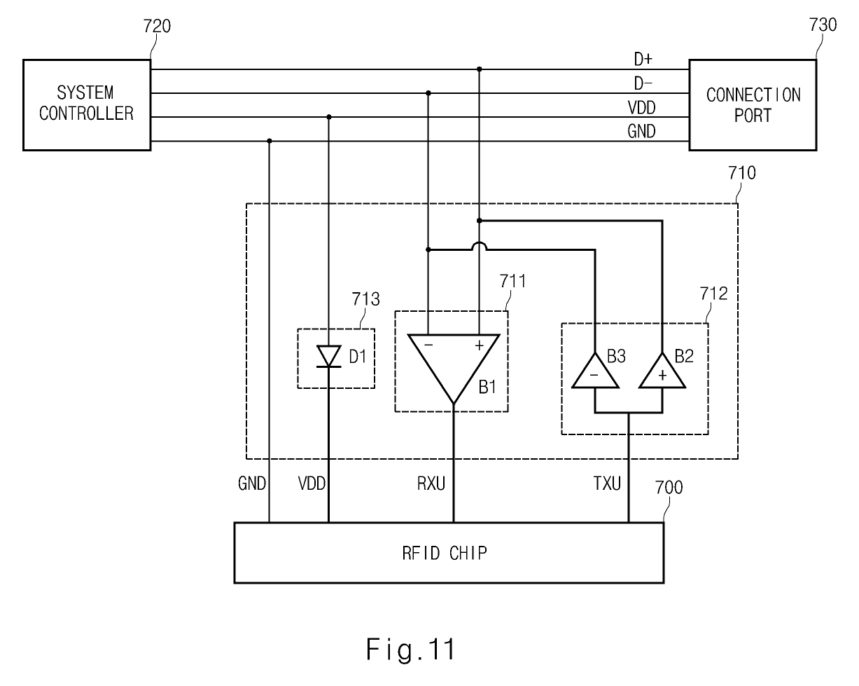

FIG. 11 is a block diagram describing operation of the connection port system shown in FIG. 10.

As shown, the connection port system includes the RFID chip 700, the interface unit 710, the system controller 720, and the connection port 730. Herein, the interface unit 710 includes a connection input buffer 711, a connection output buffer 712, and a power supply 713.

The connection input buffer 711 receives the input signal inputted via the input and output terminals D− and D+ of the connection port 730 to generate the input signal RXU. The connection input buffer 711 includes a buffer B1.

The buffer B1 shown in FIG. 11 receives two signals, but the buffer B1 can receives one or more signals according to the circuit design of the connection port system.

The input signal RXU generated by the connection input buffer 711 is inputted to the RFID chip 700 to control an operation of internal circuits in the RFID chip 700.

The connection output buffer 712 receives the output signal TXU from the RFID chip 700 to generate output signals. The connection output buffer 712 includes buffers B2 and B3. If the output signal TXU is inputted into the buffer B2, the buffer B2 outputs the output signal to the input and output terminal D+; and if the output signal TXU is inputted into the buffer B3, the buffer B3 outputs the output signal to the input and output terminal D−.

Though FIG. 11 describes that the connection output buffer 712 comprising two buffers, the connection output buffer 712 may include one or more buffers according to the circuit design of the connection port system.

The output signal generated by the connection output buffer 712 is transmitted to an external apparatus via the input and output terminals D− and D+ of the connection port 730 so that a processing result of the RFID chip 700 can be delivered to the external apparatus.

The power supply 713 may include an amplifier (not shown). If a level of the power voltage VDD inputted from an external apparatus is not sufficient to operating the RFID chip 700, the amplifier in the power supply 713 boots up the level of the power voltage VDD.

The ground voltage GND connects from the connection port 730 to the RFID chip 700.

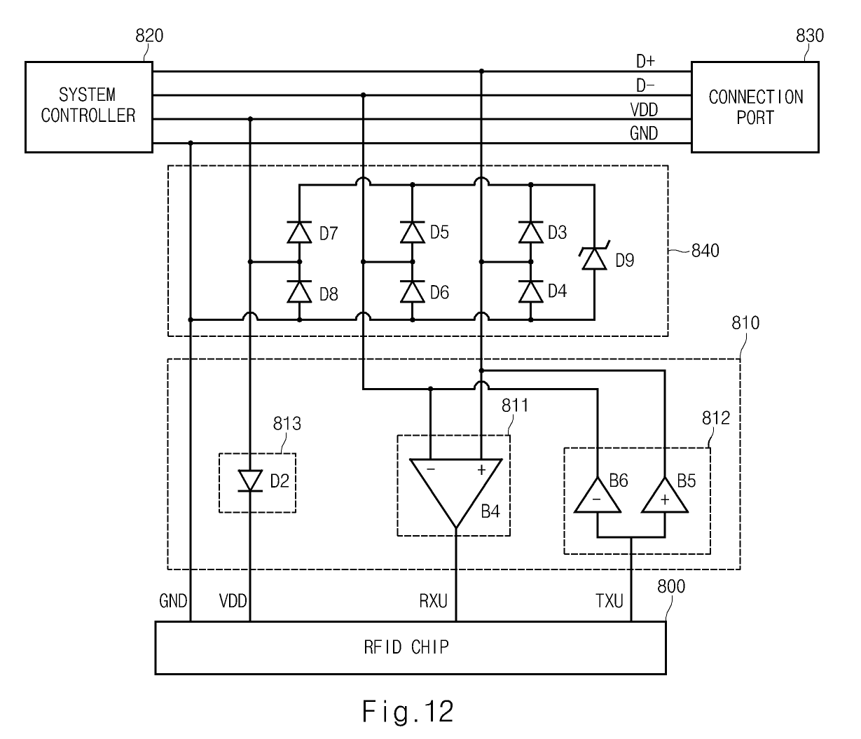

FIG. 12 is a block diagram showing a connection port system according to another embodiment of the present invention.

As shown, the connection port system includes a RFID chip 800, an interface unit 810, a system controller 820, a connection port 830, and an electro static discharge (ESD) unit 840. Herein, the interface unit 810 includes a connection input buffer 811, a connection output buffer 812, and a power supply 813.

The connection input buffer 811 receives the external input signal via the input and output terminals D− and D+ of the connection port 830 to generate an input signal RXU. The connection input buffer 811 can include a buffer B4.

The buffer B4 shown in FIG. 12 receives two signals, but the buffer B4 can receives one or more signals according to the circuit design of the connection port system.

The input signal RXU generated by the connection input buffer 811 is inputted to the RFID chip 800 to control an operation of the RFID chip 800.

The connection output buffer 812 receives an output signal TXU from the RFID chip 800 to generate output signals. The connection output buffer 812 includes buffers B5 and B6. If the output signal TXU is inputted into the buffer B5, the buffer B5 outputs the output signal via the input and output terminal D+; and if the output signal TXU is inputted into the buffer B6, the buffer B6 outputs the output signal via the input and output terminal D−.

Though FIG. 12 describes the connection output buffer 812 including two buffers, the connection output buffer 812 may include one or more buffers according to the circuit design of the connection port system.

The output signal generated by the connection output buffer 812 is transmitted to an external apparatus via the input and output terminals D− and D+ of the connection port 830 so that a processing result of the RFID chip 800 can be delivered to the external apparatus.

The power supply 813 delivers the power voltage VDD supplied from an external apparatus via the connection port 830 into the RFID chip 800.

As shown in FIG. 12, the power supply 813 may include a diode D2. The diode D2 is coupled in a forward path from the connection port 830 to the RFID chip 800.

Because of the diode D2, the power voltage VDD supplied from the external apparatus can be delivered into the RFID chip 800; but no current can flow from the RFID chip 800 to the external apparatus. Accordingly, even though a high voltage may briefly be generated inside the RFID chip 800, the high voltage will not be delivered to the external apparatus so that the external apparatus will be protected from an unexpected high voltage spike.

The power supply 813 may include an amplifier (not shown). If a level of the power voltage VDD inputted from an external apparatus is not sufficient to operate the RFID chip 800, the amplifier in the power supply 813 boots up the level of the power voltage VDD.

The ground voltage GND is connected from the connection port 830 to the RFID chip 800.

The ESD unit 840 is coupled between the connection port 830 and the interface unit 810. The ESD unit 840 protects the internal circuits of the RFID chip 800 when a high voltage having an unexpected level caused by electrostatic induction is supplied to the RFID chip 800.

The ESD unit 840 includes a plurality of diodes D3 to D9. One of the diodes may be a Zener diode, e.g., D9.

The input and output terminal D+ is coupled to an anode of the diode D3 and a cathode of the diode D4. Accordingly, currents supplied via the input and output terminal D+ can flow through the diode D3 in a forward path, but cannot flow through the diode D4 because of a reverse path.

A cathode of the diode D3 is coupled to a cathode of the diode D9, and an anode of the diode D9 is coupled to the ground voltage GND.

When a high voltage having an unexpected level caused by electrostatic induction is inputted via the input and output terminal D+ (e.g., the high voltage has a higher level than a breakdown voltage of the Zener diode D9), a reverse-path current flows through the diode D9.

That is, the current supplied via the input and output terminal D+ flows into the ground voltage GND through the diodes D3 and D9. Accordingly, since there is no high current flowing into the interface unit 810, an internal circuit of the RFID chip 800 may be protected from the high voltage.

The input and output terminal D− is coupled to an anode of the diode D5 and a cathode of the diode D6. In this case, currents supplied via the input and output terminal D− can flow through the diode D5 in a forward path, but cannot flow through the diode D6 because of a reverse path.

A cathode of the diode D5 is coupled to a cathode of the diode D9, and an anode of the diode D9 is coupled to the ground voltage GND.

When a high voltage having an unexpected level caused by electrostatic induction is inputted via the input and output terminal D1 (e.g., the high voltage has a higher level than a breakdown voltage of the Zener diode D9), a reverse-path current flows through the diode D9.

That is, the current supplied via the input and output terminal D− flows into the ground voltage GND through the diodes D5 and D9. Accordingly, since there is no high current flowing into the interface unit 810, an internal circuit of the RFID chip 800 may be protected from the high voltage.

The power voltage VDD of the connection port 830 is coupled to an anode of the diode D7 and a cathode of the diode D8. Accordingly, currents supplied from the power voltage VDD of the connection port 830 can flow through the diode D7 in a forward path, but cannot flow through the diode D8 because of a reverse path.

A cathode of the diode D7 is coupled to a cathode of the diode D9, and an anode of the diode D9 is coupled to the ground voltage GND.

When the high voltage having an unexpected level caused by electrostatic induction is inputted via the input and output terminal D+ (e.g., the high voltage has a higher level than a breakdown voltage of the Zener diode D9), a reverse-path current flows through the diode D9.

That is, the current supplied via power voltage VDD of the connection port 830 flows into the ground voltage GND through the diodes D3 and D9. Accordingly, since there is no high current flowing into the interface unit 810, an internal circuit of the RFID chip 800 may be protected from the high voltage.

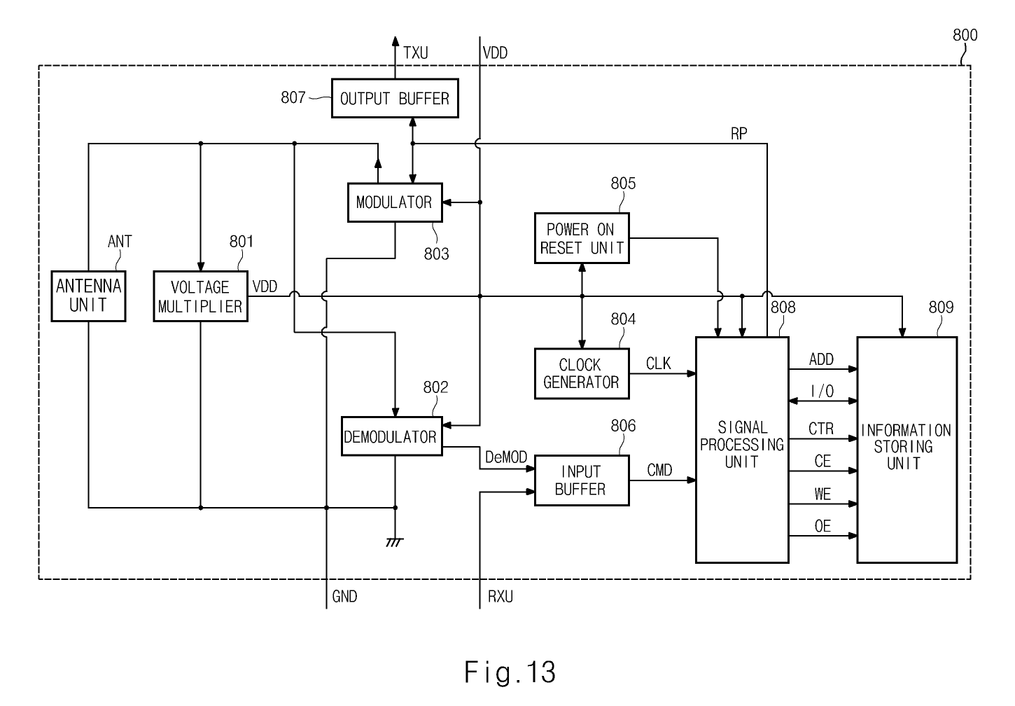

FIG. 13 is a block diagram showing a RFID chip shown in FIG. 12. Internal circuits of the RFID chip 800 shown in FIG. 13 can be applied to the RFID chip 700 shown in FIG. 11

As shown, the RFID chip 800 includes an antenna unit ANT, a voltage multiplier 801, a demodulator 802, a modulator 803, a clock generator 804, a power-on-reset unit 805, an input buffer 806, an output buffer 807, a signal processing unit 808, and an information storing unit 809.

The antenna unit ANT receives a wireless signal transmitted from a RFID reader. The wireless signal is used for supplying a power voltage VDD to the RFID chip 800 and controlling an operation of the RFID chip 800 after decoded by the demodulator 802.

The voltage multiplier 801 rectifies the wireless signal inputted from the antenna unit ANT and boosts up a voltage level to generate the power voltage VDD.

The demodulator 802 detects an instruction included in the wireless signal inputted via the antenna unit ANT to generate a demodulated signal DeMOD, and then outputs the demodulated signal DeMOD to the input buffer 806.

The modulator 803 modulates a response signal RP inputted from the signal processing unit 808 to transmit a modulated signal to the RFID reader through antenna ANT.

The clock generator 804 outputs a clock CLK to the signal processing unit 808. The clock CLK is configured to synchronize an operation of the signal processing unit 808.

The power-on-reset 805 senses the power voltage VDD generated by the voltage multiplier 801 and outputs a power-on-reset signal POR to the signal processing unit 808.

The voltage of the power-on-reset signal POR rises along with a level of power voltage VDD while the power voltage VDD transitions from a low level to a high level. The power-on-reset signal POR then changes from the high level to the low level at a time after the power voltage VDD reaches the high level. The power-on-reset signal POR resets operations of the signal processing unit 808 and the information storing unit 809 in the RFID chip 800

The input buffer 806 receives an input signal RXU (converted from an external input signal inputted through the connection port 830 from an external apparatus) and the demodulated signal DeMOD (outputted from the demodulator 802) and generates a command signal CMD. The demodulator 802 generates a command signal CMD by either performing a logic operation to the input signal RXU and the demodulated signal DeMOD or selecting one of the input signal RXU and the demodulated signal DeMOD. The command signal CMD is outputted to the signal processing unit 808.

The output buffer 807 converts a response signal RP outputted from the signal processing unit 808 into an output signal TXU and outputs the output signal TXU to the interface unit 810.

The signal processing unit 808 is supplied with the power voltage VDD by the connection port 830 or the voltage multiplier 801. The signal processing unit 808 recognizes the command signal CMD in response to the power-on-reset signal POR and the clock CLK to generate a control signal CTR. In response to the command signal CMD, the signal processing unit 808 outputs the response signal RP to the modulator 803 or the output buffer 807.

The signal processing unit 808 outputs an address ADD, an input and output data I/O, the control signal CTR, a chip enable signal CE, a write enable signal WE, and an output enable signal OE into the information storing unit 809.

The information storing unit 809 includes one or more memory cells.

The address ADD is a signal for informing which memory cells the input/output data I/O is stored in, including location information of the memory cells. The control signal CTR includes one or more signals used for controlling an operation to read the input/output data I/O from the information storing unit 809 or write the input/output data I/O to the information storing unit 809.

A chip enable signal CE is for enabling an operation of the information storing unit 809. A write enable signal WE enables a write operation for storing the input/output data I/O in the information storing unit 300. An output enable signal OE allows a read operation for outputting the input/output data I/O from the information storing unit 809.

The information storing unit 809 can include volatile or nonvolatile memory devices.

The information storing unit 809 may also include FeRAM. The data processing speed of FeRAM is typically similar to that of Dynamic Random Access Memory (DRAM). The structure of FeRAM is also similar to that of DRAM in that FeRAM includes a plurality of capacitors. However, the capacitors in a FeRAM device are made of a ferroelectric material having a high residual polarization, which in turn allows for data retention even when the power supplied to the memory device is terminated.

As described above, a system according to an embodiment of the present invention controls an operation of the RFID chip 800 in response to a signal inputted from an external apparatus through the connection port 830, a wireless signal inputted from a RFID reader through the antenna unit ANT, or a combination signal generated by performing a logic operation of the signal and the wireless signal.

Furthermore, a system according to an embodiment of the present invention may directly provide a power voltage VDD inputted from an external apparatus to the RFID chip 800 or amplify a voltage level supplied from an external apparatus by using the interface unit 810. Thus, the system can operate the RFID chip 800 without using the voltage multiplier 801 included in the RFID chip 800.

According to embodiments of the present invention, the connection port can include one or more ports such as a USB port, a 1394 port, a serial port, and etc.

Although a number of illustrative embodiments consistent with the invention have been described, it should be understood that numerous other modifications and embodiments can be devised by those skilled in the art that will fall within the spirit and scope of the principles of this disclosure. More particularly, a number of variations and modifications are possible in the component parts and/or arrangements of the subject combinations arrangement within the scope of the disclosure, the drawings and the appended claims. In addition to variations and modifications in the component parts and/or arrangements, alternative uses will also be apparent to those skilled in the art.

What is claimed is:

1. A connection port system, comprising:
a RFID chip configured to communicate with an external apparatus via a first communication medium;
a connection port configured to be coupled to the external apparatus via a second communication medium; and
an interface unit configured to electrically couple the connection port to the RFID chip, the interface unit being configured to manage communication between the connection port and the external apparatus.

2. The connection port system according to claim 1, wherein the interface unit comprises a first buffer configured to generate an input signal by buffering one or more of external input signals received through the connection port from the external apparatus and output the input signal to the RFID chip, wherein the first communication medium is a different medium from the second communication medium.

3. The connection port system according to claim 2, wherein the interface unit further comprises a second buffer configured to generate one or more of output signals by buffering an output signal outputted from the RFIP chip and output the one or more of output signals to the connection port.

4. The connection port system according to claim 3, wherein the interface unit further comprises a power supply unit configured to provide a power voltage received from the external apparatus via the connection port to the RFID chip.

5. The connection port system according to claim 4, wherein the power supply includes a diode having an anode coupled to the connection port and a cathode coupled to the RFID chip.

6. The connection port system according to claim 1, further comprising an electro static discharge (ESD) unit coupled between the connection port and a ground voltage electrode and configured to allow current to flow into the ground voltage electrode when the current having a higher level than a predetermined level is inputted through the connection port.

7. The connection port system according to claim 6, wherein the ESD unit includes a Zener diode having a cathode coupled to the connection port and an anode coupled to the ground voltage electrode.

8. The connection port system according to claim 7, wherein the predetermined level is a breakdown voltage level of the Zenor diode.

9. The connection port system according to claim 1, wherein the RFID chip comprises:
an antenna configured to receive a wireless signal from a RFID reader;
a demodulator configured to demodulate the wireless signal to generate a demodulated signal;
a third buffer configured to buffer the demodulated signal and an input signal inputted from the interface unit to generate a command signal; and
a processing unit configured to perform a control operation in response to the command signal.

10. The connection port system according to claim 9, wherein the RFID chip further comprises:
a modulator configured to modulate a response signal generated by the processing unit to transmit a modulated signal to the RFID reader through the antenna; and
a fourth buffer configured to output the response signal to the connection port.

11. The connection port system according to claim 9, wherein the RFID chip further comprises an information storing unit configured to store information inputted from the processing unit.

12. The connection port system according to claim 10, wherein the information storing unit comprises one or more Ferroelectric Random Access Memory.

13. A connection port system, comprising:
a connection port coupled to an external apparatus and configured to communicate with the external apparatus via a first communication medium;
an interface unit coupled to input and output terminals of the connection port and configured to control a connection state between the external apparatus and the connection port; and
a RFID chip coupled to the interface unit and configured to communicate with the external apparatus via a second communication medium,
wherein the interface unit is configured to control the connection state of the input and output terminals in response to a security control signal outputted from the RFID chip.

14. The connection port system according to claim 13, wherein the RFID chip determines a logic level of the security control signal in response to a wireless input signal received from the external apparatus, wherein the first communication medium uses a physical connection and the second communication medium uses a wireless connection.

15. The connection port system according to claim 13, wherein the RFID chip comprises a security processing unit configured to detect a security instruction in a wireless input signal to output the security control signal.

16. The connection port system according to claim 13, wherein the interface unit comprises:
a security controller configured to output a security enable signal in response to the security control signal; and
a driving unit configured to control a connection between the input and output terminals in response to the security enable signal.

17. The connection port system according to claim 16, wherein the driving unit comprises a first switching unit configured to selectively couple a first input/output terminal to a second input/output terminal in response to the security enable signal, wherein the first and second input/output terminals are included in the input and output terminals

18. The connection port system according to claim 17, wherein the first switching unit comprises a first NMOS transistor having a gate configured to receive the security enable signal, wherein the first NMOS transistor is located between the first and second input/output terminals.

19. The connection port system according to claim 17, wherein the first switching unit is turned on when the security enable signal is in a logic high level.

20. The connection port system according to claim 16, wherein the driving unit comprises a switching unit configured to selectively decouple the input and output terminals to each other in response to the security enable signal.

21. The connection port system according to claim 20, wherein the switching unit comprises:
a second switching unit configured to selectively decouple a connection node between third input/output terminals included in the input and output terminals; and
a third switching unit configured to selectively decouple a connection node between fourth input/output terminals included in the input and output terminals.

22. The connection port system according to claim 21, wherein the second switching unit comprises a second NMOS transistor having a gate configured to receive the security enable signal, wherein the second switching unit is located between the third input/output terminals.

23. The connection port system according to claim 21, wherein the third switching unit comprises a third NMOS transistor having a gate configured to receive the security enable signal, wherein the third switching unit is located between the fourth input/output terminals.

24. The connection port system according to claim 20, wherein the switching unit is turned off when the security enable signal is in a logic low level.

25. The connection port system according to claim 16, wherein the driving unit comprises a pull-down unit configured to pull down a potential of the input and output terminals in response to the security enable signal.

26. The connection port system according to claim 25, wherein the switching unit comprises:
a fourth switching unit configured to pull down a potential of a fifth input/output terminal included in the input and output terminals; and
a fifth switching unit configured to pull down a potential of a sixth input/output terminal included in the input and output terminals.

27. The connection port system according to claim 26, wherein the fourth switching unit comprises a fourth NMOS transistor having a gate configured to receive the security enable signal, wherein the fourth switching unit is located between the fifth input/output terminal and a ground voltage.

28. The connection port system according to claim 26, wherein the fifth switching unit comprises a fifth NMOS transistor having a gate configured to receive the security enable signal, wherein the fourth switching unit is located between the sixth input/output terminal and a ground voltage.

29. The connection port system according to claim 25, wherein the switching unit is turned on when the security enable signal is in a logic high level.

30. The connection port system according to claim 13, wherein the RFID chip further comprises:
a demodulator configured to demodulate a wireless input signal;
a modulator configured to modulate a response signal to output a modulated signal;
a digital processing unit configured to recognize a command signal inputted from the demodulator to generate the response signal; and
an information storing unit configured to store information outputted from the digital processing unit.

31. The connection port system according to claim 30, wherein the information storing unit comprises a Ferroelectric Random Access Memory.

32. The connection port system according to claim 13, further comprising a system controller coupled between the connection port and the input and output terminals, and wherein the system controller and the RFID chip commonly shares a power source

33. The connection port system according to claim 13, wherein the first communication medium and the second communication medium are different media.
